(19) United States
(12) Patent Application Publication
(10) Pub. No.: US 2025/0167256 A1
(43) Pub. Date: May 22, 2025

(54) BIPOLAR PLATE FOR AN ELECTROCHEMICAL SYSTEM

(71) Applicant: Reinz-Dichtungs-GmbH, Neu-Ulm (DE)

(72) Inventors: André SPEIDEL, Schwendi (DE); Stephan WENZEL, Pfaffenhofen (DE); Bernd GAUGLER, Ulm (DE)

(21) Appl. No.: 18/954,330

(22) Filed: Nov. 20, 2024

(30) Foreign Application Priority Data
Nov. 21, 2023 (DE) 20 2023 106 851.0
Dec. 13, 2023 (DE) 20 2023 107 360.3
Dec. 21, 2023 (DE) 20 2023 107 593.2

(51) Int. Cl. H01M 8/0228; C25B 13/02; C25B 13/05; H01M 8/0208; H01M 8/0258

(52) U.S. Cl. CPC H01M 8/0228; C25B 13/02; C25B 13/05; H01M 8/0208; H01M 8/0258

(57) ABSTRACT

The present disclosure relates to a bipolar plate for an electrochemical system and an electrochemical system comprising at least one such bipolar plate. The bipolar plate comprises a first separator plate and a second separator plate, which are arranged on top of each other. At least one of the separator plates has, on the side that faces the other separator plate, only partially coated surface areas, which are provided with a coating that increases the electrical conductivity.

### CROSS REFERENCE TO RELATED APPLICATIONS

This application claims priority to German Utility Model Application No. 20 2023 106 851.0, entitled “BIPOLAR PLATE FOR AN ELECTROCHEMICAL SYSTEM”, filed Nov. 21, 2023, and German Utility Model Application No. 20 2023 107 360.3, entitled “BIPOLAR PLATE FOR AN ELECTROCHEMICAL SYSTEM”, filed Dec. 13, 2023, and German Utility Model Application No. 20 2023 107 593.2, entitled “BIPOLAR PLATE FOR AN ELECTROCHEMICAL SYSTEM”, filed Dec. 21, 2023. The entire contents of each of the above-identified applications are hereby incorporated by reference for all purposes.

### TECHNICAL FIELD

The present disclosure relates to a bipolar plate for an electrochemical system and an electrochemical system comprising at least one such bipolar plate.

### BACKGROUND AND SUMMARY

Known electrochemical systems, for example fuel cell systems or electrochemical compressor systems, redox flow batteries and electrolyzers, usually comprise a large number of bipolar plates arranged in a stack so that each two adjacent bipolar plates enclose an electrochemical cell. The bipolar plates usually comprise two separator plates, which are connected to each other along their rear sides that face away from the electrochemical cells. The bipolar plates can be used, for example, for the electrical contacting of the electrodes of the individual electrochemical cells (e.g. fuel cells) and/or the electrical connection of neighboring cells (series connection of the cells).

The separator plates of the bipolar plates can have channel structures for supplying the cells with one or more media and/or for discharging media. In the case of fuel cells, the media can be, for example, fuels (e.g. hydrogen or methanol), reaction gases (e.g. air or oxygen) or a coolant as supplied media and reaction products and heated coolant as discharged media. Furthermore, the bipolar plates can be used to conduct the waste heat generated in the electrochemical cell, for example during the conversion of electrical or chemical energy in a fuel cell, as well as to seal the various media or cooling channels off from each other and/or to the outside. In the case of fuel cells, the reaction media, i.e. fuel and reaction gases, are normally conducted on the mutually averted surfaces of the individual plates, while the coolant is conducted between the individual plates. The bipolar plates usually have at least one or more through-openings. Through the through-openings, the media and/or the reaction products can be fed to the electrochemical cells bounded by adjacent bipolar plates of the stack, or into the cavity formed by the separator plates of the bipolar plate, or can be discharged from the cells or from the cavity. The electrochemical cells, in particular of a fuel cell, can, for example, each comprise a membrane electrode assembly (MEA) with a polymer electrolyte membrane (PEM), electrodes and catalyst layers. Adjacent to the MEA, the MEA system can also have one or more gas diffusion layers (GDL), which are usually oriented towards the separator plates, in particular towards the bipolar plates of fuel cell systems, and are configured as a carbon fleece, for example. In an example fuel cell, hydrogen carried on an anode side is typically converted to water, with oxygen being carried on a cathode side. Protons produced during the oxidation of hydrogen pass from the anode side through the MEA to the cathode, where they react with the oxygen and electrons to form water. The membrane of the fuel cell is electrically insulating and prevents an electrical short circuit between the anode and cathode. The electrons are guided separately from the anode to the cathode so that the electric current can be utilized.

Nowadays, most fuel cell systems are operated with an excess of oxidizing agent. It has been found that the reaction takes place to a greater extent at the points where there is a particularly high concentration of oxidation medium than at other points in the electrochemically active region. This can be the case, for example, in the immediate vicinity of entry points of the oxidizing agent into the electrochemically active region. The stronger conversion of reactants leads to a particularly high current density in the regions where there is a greater excess of oxidizing agent. This results in an uneven distribution of the current density over the active region. A high reactant conversion leads to a high load on the membrane, while the membrane only experiences a low load in regions of low material conversion. Overload regions have a negative effect on the service life of the MEA, that is, its membrane. Low-load regions have the disadvantage of high region-related costs compared to output, especially as the MEA is a comparatively expensive component. Similar phenomena can occur with PEM electrolyzers, as water is the only medium supplied and an ever-increasing proportion of oxygen is carried along in the water on its way across the bipolar plate, while the actual proportion of water is reduced at the same time. In particular, low load regions may occur towards the end of the water path on a bipolar plate.

In other electrochemical systems, especially other polymer membrane-based electrochemical systems, other factors can lead to unequal loads on the surface of the polymer membrane.

It is therefore the object of the present disclosure to propose an improved bipolar plate and/or an improved electrochemical system, in particular in such a way that a service life of the bipolar plate and/or a service life of an MEA or polymer membrane arranged between bipolar plates in a bipolar plate stack is increased. Additionally or alternatively, the object may be to reduce the costs depending on the performance of an electrochemical system.

These tasks are at least partially solved by the bipolar plate and the electrochemical system disclosed herein.

The proposed bipolar plate for an electrochemical system has a first separator plate and a second separator plate, which are arranged on top of each other.

The first separator plate has, on a side that faces away from the second separator plate, embossed webs and channels for guiding a first fluid.

The second separator plate has on a side that faces away from the first separator plate, embossed webs and channels for guiding a second fluid.

The first and second separator plates each have webs and channels on their mutually-facing sides, for guiding a cooling medium along an inner side of the bipolar plate. The mutually-facing sides may in the following be referred to as coolant sides.

At least one of the separator plates has, on the side that faces the other separator plate, i.e. its coolant side, only in sections coated surface regions, which are provided with a coating that increases the electrical conductivity.

Surface regions that are only coated in sections can have the technical effect of increasing the electrical conductivity of the bipolar plate in these regions. In this way, a more homogeneous current density can be achieved.

The coating that increases the electrical conductivity may be referred to here and in the following as a coating.

In one embodiment, a proportion of the coated surface regions of the entire surface is distributed heterogeneously over the entire surface.

In one embodiment, the proportion of the coated surface regions may be formed on the side of the first separator plate that faces the second separator plate and/or the proportion of the coated surface regions may be formed on the side of the second separator plate that faces the first separator plate. The proportions of the coated surface regions of the coated regions of the coolant side of the first separator plate can be of the same type and/or uniform compared to proportions of the coated regions of the coolant side of the second separator plate. Alternatively, the proportions of the coated surface regions of the coated regions of the coolant side of the first separator plate can have different shapes and/or be of different types compared to proportions of the coated regions of the coolant side of the second separator plate.

At least one of the separator plates can therefore be precisely coated in sections with the coating that increases the electrical conductivity on the coolant side. In particular, the separator plate, which is coated in sections with the coating that increases the electrical conductivity, is not coated over its entire surface with the coating that increases the electrical conductivity. The other one of the separator plates of the bipolar plate can optionally be fully coated on the coolant side with the coating that increases the electrical conductivity, or partially coated with the coating that increases the electrical conductivity, or not coated with the coating that increases the electrical conductivity.

The first separator plate can be partially or fully coated on a side that faces away from the second separator plate, hereinafter referred to as the gas side.

The second separator plate can be partially or fully coated on a side that faces away from the first separator plate, hereinafter referred to as the gas side.

In particular, the first separator plate can have web regions on its gas side that are coated at least in some regions or over the entire surface and/or the second separator plate can have web regions on its gas side that are coated at least in some regions or over the entire surface.

The first separator plate can have a first electrochemically active region and the second separator plate can have a second electrochemically active region. The first electrochemically active region and the second electrochemically active region can overlap each other and form an active region of the bipolar plate in an overlapping region. The coated surface regions can be located in the active region on at least one side of at least one of the separator plates.

The coated surface regions can be formed over the entire surface or in sections, for example in the region of the web surfaces of one or both separator plates.

The first separator plate and the second separator plate can form at least one contact surface between them. The coated surface regions can be formed in the region of the contact surfaces. In many bipolar plates, the two separator plates in the active region only touch in the web regions and the contact surfaces form accordingly on the web regions. In this case, optionally at least sections of the web surfaces that are in contact with each other are coated. On the other hand, there are bipolar plates in which the flow fields of the active regions of both separator plates are interleaved. With these bipolar plates, contact between the separator plates can take place via the flanks. In this case, optionally at least sections of the flanks that are in contact with each other are coated.

The coated surface regions can alternatively or additionally be formed in sections in regions between the web surfaces and/or in the regions between the contact surfaces of the first separator plate and/or the second separator plate. For example, an additional conduction along the coated surface of this separator plate, in the coating, can also take place, via such a coating surface of a separator plate that is not directly connected to another separator plate.

The first separator plate can have a first region, a second region and optionally a third region in the electrochemically active region of at least one of its sides. The coated surface areas can be distributed in such a way that a proportion A11 of the coated surface areas in the first area of the entire surface of the first area is smaller than a proportion A12 of the coated surface areas in the second area of the entire surface of the second area and/or that a proportion A13 of the coated surface areas in the third area of the entire surface of the third area is smaller than a proportion A12 and/or A11 of the coated surface areas in the second area of the entire surface of the second area and/or that a proportion A13 of the coated surface areas in the third area of the entire surface of the third area is smaller than a proportion A12 and/or A11.

The second separator plate can have a first region, a second region and optionally a third region in the electrochemically active region of at least one of its sides. The coated surface regions can be distributed in such a way that a proportion A21 of the coated surface regions in the first region of the entire surface of the first region is smaller than a proportion A22 of the coated surface regions in the second region of the entire surface of the second region and/or that a proportion A23 of the coated surface regions in the third region of the entire surface of the third region is smaller than a proportion A22 and/or A21.

A ratio A11/A12 of the first separator plate and/or a ratio A21/A22 of the second separator plate between the proportion A11 or A21 of the coated surface regions in the first region and the proportion A12 or A22 of the coated surface regions in the second region can be less than 0.9, optionally less than 0.7, optionally less than 0.5.

Additionally or alternatively, a ratio A13/A12 of the first separator plate and/or a ratio A23/A22 of the second separator plate between the proportion A13 or A23 of the coated surface regions in the third region and the proportion A12 or A22 of the coated surface regions in the second region can be less than 0.9, optionally less than 0.7, optionally less than 0.5.

At least the side of the first separator plate that faces the second separator plate can be configured such that a proportion of the coated surface regions of the entire surface of the first and/or second and/or third region of the first electrochemically active region differ from one another by more than 5%, optionally by more than 10%, optionally by more than 20%, optionally by more than 30%.

At least the side of the second separator plate that faces the first separator plate can be configured such that a proportion of the coated surface regions of the entire surface of the first and/or second and/or third region of the second electrochemically active region differ from one another by more than 5%, optionally by more than 10%, optionally by more than 20%, optionally by more than 30%.

In one embodiment, the respective separator plate can be configured in such a way that only one of the regions, for example the second region, has the coated surface regions. Within this one area, the coating itself may be distributed heterogeneously over the surface areas.

The bipolar plate can be designed to be operated at a specific operating point of an electrochemical system. The determined operating point may comprise a certain concentration gradient of the first fluid along the first electrochemically active region. The coating distribution can be adapted to the concentration gradient of the first fluid, so that a proportion of coated surface regions in sections of the active region with a comparatively low concentration of the first fluid is comparatively large and a proportion of coated surface regions in sections of the active region with a comparatively high concentration of the first fluid is comparatively small. This is especially true when oxygen or air is considered the first fluid in a system that otherwise operates with excess oxygen.

The first separator plate can have a first inlet port for supplying of the first fluid and a first outlet port for discharging the first fluid. The first inlet opening can be fluidically connected to the first electrochemically active region via a first inlet region and the first outlet opening can be fluidically connected to the first electrochemically active region via a first outlet region, so that the first fluid can be conducted successively through the first inlet region, the first electrochemically active region and the first outlet region.

The second region can be located closer to the outlet opening than the first region and the optional third region. For example, the second region may be located in a section of the electrochemically active region in which a considerable proportion of oxygen has already been electrochemically converted.

The bipolar plate can be configured in such a way that a flow direction of the first fluid is opposite to a flow direction of the second fluid. A proportion of the coated surface regions on at least the side of the first separator plate that faces the second separator plate and/or the side of the second separator plate that faces the first separator plate can increase at least in sections along the flow direction of the first fluid. Optionally, the proportion initially increases and then either decreases again or remains essentially constant.

In principle, it is possible to use the distribution of the coating for fine adjustment of the conductivity distribution, particularly in the case of fixed embossed and punched structures of a bipolar plate or its separator plates.

The above-mentioned region percentages, i.e. the proportion of the coated surface regions in the total surface of a region, can be determined in relation to a projection perpendicular to the plate plane or in relation to a flat projection of the embossed regions.

In one embodiment, at least one of the separator plates of the bipolar plate may consist of or contain a steel such as a stainless steel, or a titanium alloy such as a titanium alloy of group 1. The respective separator plate may then consist in sections of this material or overall. For example, the substrate of the separator plate may be electrically conductive over its entire area.

The coating on the at least one side of the bipolar plate that faces the other separator plate may contain one or more of the following substances or consist of one or more of these substances or alloys thereof: electrically conductive materials, such as electrically conductive oxides, carbon, electrically conductive carbon layers, metal nitrides and metal oxynitrides, such as TIN, TiON (with varying oxygen/nitrogen ratio), CrN, Cr2N, metal carbides, metal borides, metal silicides and/or silicon carbide metals such as noble metals, in particular Au, Ag or Pt, non-noble metals, such as Ti, Zr, Nb, Ta or Cr. If there are coatings on both separator plates on the mutually-facing sides, these can be identical, different but contain the same substances or be fundamentally different. Any coating present on at least one of the gas sides may also comprise one or more of the aforementioned substances or consist of one or more of these substances or alloys thereof, whereby the coating(s) may differ from the first-mentioned coating.

The coating can be essentially the same over the entire coated surface of one side of the separator plate. Alternatively, the coating can be of different types over the entire coated surface.

The coating can be single-layered or multi-layered. The coating thickness depends on the coating material used. For example, the coating thickness may be greater than a minimum thickness, which in turn depends on the material.

Heterogeneous in the sense of the present disclosure is not intended to mean that all web surfaces are fully coated and all channels are free of coating.

The present disclosure further comprises an electrochemical system comprising a plurality of bipolar plates as described above.

Examples of embodiments of the bipolar plate are shown in the figures and are explained in more detail in the following description.

### BRIEF DESCRIPTION OF THE FIGURES

FIG. 1 schematically shows a perspective illustration of an electrochemical system comprising a plurality of separator plates or bipolar plates arranged in a stack.

FIG. 2 shows a schematic perspective view of two bipolar plates of the system according to FIG. 1 with a membrane electrode assembly (MEA) arranged between the bipolar plates using the example of a fuel cell system.

FIG. 3 schematically shows a cross-section along the line B-B of FIG. 2, where the cooling sides of the separator plates are fully coated and the gas sides are coated on the roofs of the webs.

FIG. 4A schematically shows a cross-section along the line B-B of FIG. 2; wherein a cooling side of one of the separator plates is coated over the entire surface and a cooling side of the other separator plate is coated only in the area that is further away from a transition area.

FIG. 4B schematically shows a cross-section along the line B-B of FIG. 2; wherein a cooling side of one of the separator plates is fully uncoated and a cooling side of the other separator plate is only coated in the region that is arranged closer to a transition region.

FIG. 5 schematically shows a cross-section along the line A-A of FIG. 2, whereby the separator plates are nested in the illustrated section.

FIG. 6A is a schematic top view of a cooling side of a section of an exemplary separator plate.

FIG. 6B is a schematic top view of a cooling side of a section of an exemplary separator plate.

FIG. 6C is a schematic top view of a cooling side of a section of an exemplary separator plate.

FIG. 6D is a schematic top view of a cooling side of a section of an exemplary separator plate.

FIG. 7 is a schematic top view of a cooling side of an exemplary separator plate with an unevenly distributed proportion of coated surface regions on the entire cooling side surface of the electrochemically active region.

FIG. 8 is a schematic top view of a cooling side of an exemplary separator plate with an unevenly distributed proportion of coated surface regions on the entire cooling side surface of the electrochemically active region.

FIG. 9 is a schematic top view of a cooling side of an exemplary separator plate with an unevenly distributed proportion of coated surface regions on the entire cooling side surface of the electrochemically active region.

FIG. 10 is a schematic top view of a cooling side of an exemplary separator plate with an unevenly distributed proportion of coated surface regions on the entire cooling side surface of the electrochemically active region.

FIG. 11 is a schematic top view of a cooling side of an exemplary separator plate with an unevenly distributed proportion of coated surface regions on the entire cooling side surface of the electrochemically active region.

FIG. 12 is a schematic top view of a cooling side of an exemplary separator plate with an unevenly distributed proportion of coated surface regions on the entire cooling side surface of the electrochemically active region.

### DETAILED DESCRIPTION

Here and below, features that recur in different figures are denoted in each case by the same or similar reference signs. In some cases, the elements of the figures are shown schematically and enlarged, so they can in particular show separations—possibly only in sections—that do not actually exist.

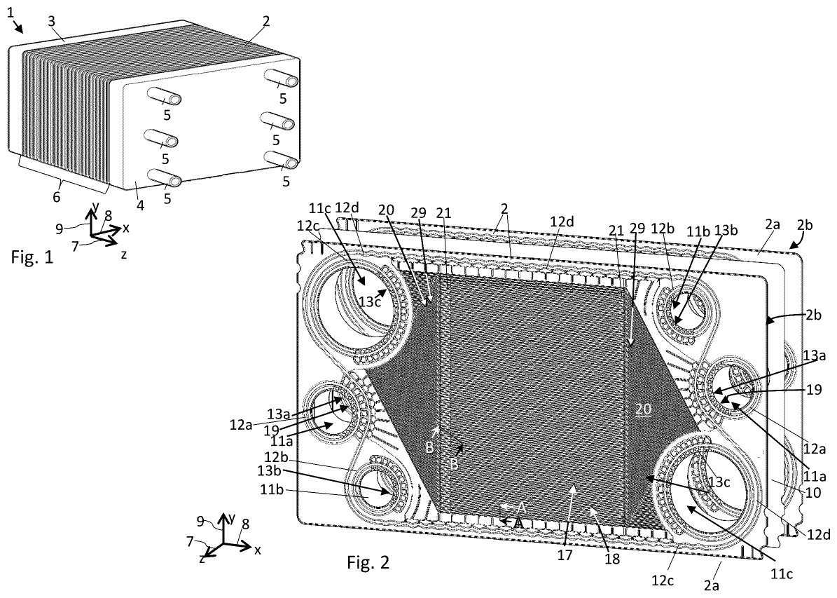

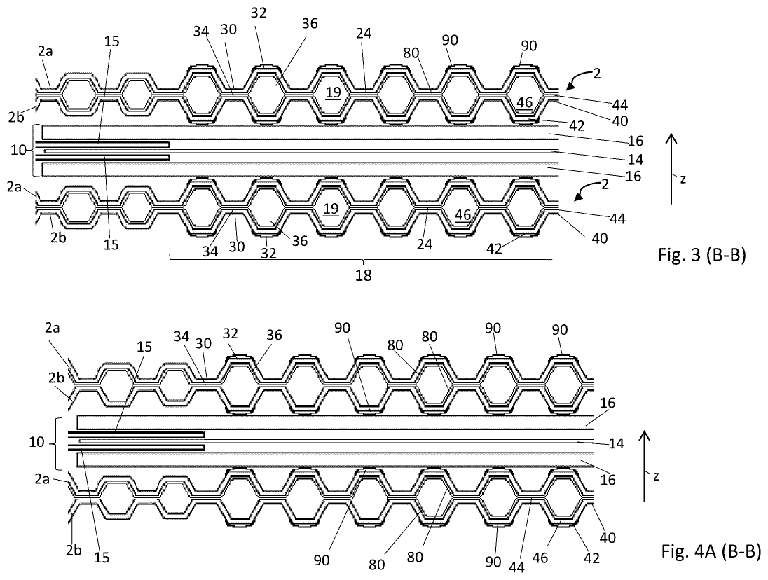

FIG. 1 shows an electrochemical system 1 comprising a plurality of structurally identical metal bipolar plates 2, which are arranged in a stack 6 and are stacked along a z-direction 7. The bipolar plates 2 of the stack 6 are clamped between two end plates 3, 4. The z-direction 7 is also called the stacking direction. In the present example, the system 1 is a fuel cell stack. In each case two adjacent bipolar plates 2 of the stack enclose between them an electrochemical cell which serves, for example, for conversion of chemical energy into electrical energy. To form the electrochemical cells of system 1, a membrane electrode assembly (MEA) is arranged between adjacent bipolar plates 2 of the stack (see e.g. FIG. 3A). The MEAs typically each contain at least one membrane, e.g. an electrolyte membrane. Furthermore, a gas diffusion layer (GDL) may be arranged on one or both surfaces of the MEA.

In alternative embodiments, the system 1 may also be configured as an electrolyzer, as an electrochemical compressor, or as a redox flow battery. Bipolar plates can likewise be used in these electrochemical systems. The structure of these bipolar plates can then correspond to the structure of the bipolar plates 2 described in more detail here, even if the media fed onto or through the bipolar plate in an electrolyzer, in an electrochemical compressor or in a redox flow battery may differ in each case from the media used for a fuel cell system.

The z-axis 7, together with an x-axis 8 and a y-axis 9, spans a right-handed Cartesian coordinate system. The bipolar plates 2 each define a plate plane, whereby the plate planes of the separator plates 2a, 2b are each aligned parallel to the x-y plane and thus perpendicular to the stacking direction or to the z-axis 7. The end plate 4 comprises a plurality of media connections 5, via which media can be fed to the system 1 and via which media can be discharged from the system 1. These media that can be supplied to the system 1 and discharged from the system 1 may comprise e.g. fuels such as molecular hydrogen or methanol, reaction gases such as air or oxygen, reaction products such as water vapor or depleted fuels or coolants such as water and/or glycol.

FIG. 2 shows, in a perspective view, two adjacent bipolar plates 2 of an electrochemical system of the same type as the system 1 from FIG. 1, as well as a membrane electrode assembly (MEA) 10, known from the prior art, which is arranged between these adjacent bipolar plates 2, the MEA 10 in FIG. 2 being largely obscured by the bipolar plate 2 that faces towards the viewer. The bipolar plate 2 is formed of two separator plates 2a, 2b which are joined together by a material bond (see for example FIG. 3), of which only the first separator plate 2a that faces towards the viewer is visible in FIG. 2, said first separator plate concealing the second separator plate 2b. The separator plates 2a, 2b may each be manufactured from a metal sheet, for example from a stainless-steel sheet. The separator plates 2a, 2b may for example be welded to one another, for example by laser welds. On one side the separator plates 2a, 2b can be tightly welded along and at a distance from their outer edges or at least along the inner edge of a part of the through-openings along sealing seams, such as outside and/or inside the perimeter bead 12d. Further weld seams are possible.

The separator plates 2a, 2b have through-openings, which are aligned with each other and form through-openings 11a-c of the bipolar plate 2. When a plurality of bipolar plates of the same type as the bipolar plate 2 are stacked, the through-openings 11a-c form ducts which extend through the stack 6 in the stacking direction 7 (see FIG. 1). Typically, each of the ducts formed by the through-openings 11a-c is fluidically connected to one of the media ports 5 in the end plate 4 of the system 1. By way of the ducts formed by the through-openings 11a, it is possible for e.g. coolant to be introduced into the stack or discharged from the stack. By contrast, the ducts formed by the through-openings 11b, 11c may be configured to supply the electrochemical cells of the fuel cell stack 6 of the system 1 with fuel and with reaction gas and to discharge the reaction products from the stack. The media-conducting through-openings 11a-11c are formed substantially parallel to the plate plane.

In order to seal off the through-openings 11a-c from the interior of the stack 6 and from the environment, the first separator plates 2a each have sealing arrangements in the form of sealing beads 12a-c that are each arranged around the through-openings 11a-c and each fully enclose the through-openings 11a-c. The second separator plates 2b have corresponding sealing beads for sealing the through-openings 11a-c on the rear side of the separator plates 2 that faces away from the viewer of FIG. 2 (not shown). Alternatively, elastomer seals can also be used.

In an electrochemically active region 18, the first separator plates 2a have a flow field 17 with structures for guiding a reaction medium along the outer side of the separator plate 2a on the outer side that faces the viewer of FIG. 2. These structures are given in FIG. 2 by a plurality of webs 32, 42 and channels 30, 40 extending between the webs 32, 42 and bounded by the webs 32, 42. On the outer side of the bipolar plates 2 that faces the viewer of FIG. 2, the first separator plates 2a also each have a distribution and collection region 20. Distribution or collection regions 20 each comprise structures that are set up to distribute a medium introduced into the distribution region 20 from a first of the two through-openings 11b via the active region 18 or to collect or bundle a medium flowing from the active region 18 towards the second of the through-openings 11b. The fluid-guiding structures 29 of both distribution or collection regions 20 are likewise provided in FIG. 2 by webs and channels that run between the webs and that are delimited by the webs. In the following text, only the distribution region 20 will be discussed for the sake of simplicity; the corresponding statements can equally apply to a collection region 20. Between the distribution and collection regions and the active region 20, a transition region 21 with a lower web height than the two adjacent regions can be arranged on the gas sides.

The sealing beads 12a-12c have passages 13a-13c, which allow passage of medium between the associated through openings 12a-12c and the distribution region 20 on a gas side or in the interior of the bipolar plate 2.

The first separator plates 2a also each have a further sealing arrangement in the form of a perimeter bead 12d, which surrounds the flow field 17 of the active region 18, the distribution and collection regions 20 and the through-openings 11b, 11c and seals these off from the through-opening 11a, i.e. from the coolant circuit, and from the environment of the system 1. The second separator plates 2b each comprise corresponding perimeter beads. The structures of the active region 18, the distribution structures of the distribution and collection region 20 and the sealing beads 12a-d are each formed integrally with the separator plates 2a and molded into the separator plates 2a or 2b, e.g. in a stamping or deep-drawing process or by means of hydroforming.

The bipolar plate 2 is formed from two separator plates, namely separator plates 2a, 2b, which are joined together with a material bond (see e.g. FIGS. 3 to 5), of which only the first separator plate 2a that faces the observer is visible in FIG. 2, which conceals the second separator plate. The separator plates 2a, 2b can each be formed from a shaped metal sheet, e.g. from an embossed or deep-drawn stainless-steel sheet. This metal sheet may have, for example, a thickness of at most 150 μm, optionally at most 100 μm, optionally at most 90 μm, optionally at most 80 μm. The separator plates may be welded to one another, for example by laser welds.

FIG. 3 schematically shows a cross-section B-B, drawn in FIG. 2 through a section of the plate stack 6 of the system 1 of FIG. 1, whereby the sectional plane is aligned in the z-direction and thus perpendicular to the plate planes of the bipolar plates 2.

On its side that faces away from the second separator plate 2b, the first separator plate 2a has molded-in, first channels 30 extending next to each other for guiding the media, which are separated from one another by first webs 32 formed between the first channels 30. On a side of the first separator plate 2a that faces the second separator plate 2b, the first channels 30 form first protrusions 34 and the first webs 32 form first grooves 36. On its side that faces away from the first separator plate 2a, the second separator plate 2b has molded-in, second channels 40 extending next to each other for guiding the media, which are separated from one another by second webs 42 formed between the second channels 40. Here, on a side of the second separator plate 2b that faces the first separator plate 2a, the second channels 40 form second protrusions 44 and the second webs 42 form second grooves 46.

The identically constructed bipolar plates 2 of the stack each comprise the first metallic separator plate 2a previously described and the second metallic separator plate 2b previously described. The structures for media conduction along the outer surfaces of the separator plates 2 (hereinafter also referred to as gas sides) can be seen, here in particular in the form of the webs 32 and 42 and channels 30 and 40 bounded by the webs 32 and 42. Cooling channels are shown in the cavity 19 between adjacent separator plates 2a, 2b. Adjacent to the sealing beads and between the cooling channels both in the distribution or collection region 20 and in the active region 18, the two separator plates 2a, 2b lie on top of each other in a contact region 24 (see FIG. 2). Furthermore, the two separator plates 2a, 2b are tightly connected to each other along the sealing beads, for example by means of laser welding seams.

A membrane electrode assembly (MEA) 10, known for example from the prior art, is arranged in each case between adjacent bipolar plates 2 of the stack. The MEA 10 typically comprises a membrane 14, e.g. an electrolyte membrane including electrodes and catalyst layers not shown separately here, and an edge section 15 connected to the membrane 14. For example, the edge section 15 can be bonded to the membrane 14. Furthermore, gas diffusion layers 16 may additionally be arranged in the active region 18. The gas diffusion layers 16 enable a flow across the membrane 14 over the largest possible region of the surface of the membrane 14 and can thus improve the proton transfer via the membrane 14. The gas diffusion layers 16 can, for example, be arranged on both sides of the membrane at least in the active region 18 between the adjacent bipolar plates 2. The gas diffusion layers 16 may be, for example, formed from a fiber fleece or comprise a fiber fleece.

In the present case, the term “electrochemically active region” is used to designate the region of the separator plate 2a, 2b that is opposite an electrochemically active region of the MEA 10 when the separator plate 2a, 2b is arranged in an electrochemical system. The membrane 14 of the MEA 10 extends in each case at least across the active region 18 of the abutting separator plates 2, where it enables a proton transfer via or through the membrane 14. The actual active region 18 is limited by the edge portion 15 of the MEA. This means that the membrane does not extend into the distribution or collection region 20. The edge portion 15 of the MEA 10 serves in each case for positioning, fastening and sealing the membrane between the adjoining separator plates 2.

In FIG. 3, the inner sides, i.e. the coolant sides, of the first separator plate 2a and the second separator plate 2b are provided over their entire surface with a coating 80 that increases the electrical conductivity. This is known from the state of the art. The outer sides, i.e. the gas sides of the first separator plate 2a and the second separator plate 2b are coated with a coating 90 on the roofs of the webs. The coating 90 on the gas sides can be the same coating as the coating 80 on the coolant side(s) or another coating that also increases the electrical conductivity or another coating, for example to prevent corrosion.

FIG. 4A schematically shows a cross-section B-B, drawn in FIG. 2, through a section of the plate stack 6 of the system 1 of FIG. 1, whereby the sectional plane is aligned in the z-direction and thus perpendicular to the plate planes of the bipolar plates 2. The first separator plate 2a has a full-surface coating 80 on the side that faces the other separator plate 2b, i.e. its coolant side, which increases the electrical conductivity. On the side that faces the other separator plate 2a, i.e. its coolant side, the second separator plates 2b have surface regions that are coated only in sections, which are provided with the coating 80 that increases the electrical conductivity. The coolant side of the separator plates 2b are only coated in the region that is further away from the transition region, recognizable by the edge sections 15. The outer sides (gas sides) of the first and second separator plates 2a and 2b are only coated with a coating 90 on the web roofs. For example, the transition region can be arranged on the inlet side for oxygen or air and oxygen can be reduced on the gas side carrying the oxygen in regions further away from this inlet, such as in significantly distant regions. Here, the coating 80 on the opposite coolant side can be used to achieve a uniform conductivity and thus a more even utilization of the MEA.

FIG. 4B schematically shows a cross-section B-B, drawn in FIG. 2, through a section of the plate stack 6 of the system 1 of FIG. 1, the sectional plane being aligned in the z-direction and thus perpendicular to the plate planes of the bipolar plates 2. The first separator plate 2a is completely uncoated on the side that faces the other separator plate 2b, i.e. its coolant side. The outer sides (gas sides) of the first separator plates 2a have an electrically conductive coating 90 over their entire surface. On the sides that face the other separator plates 2a, the second separator plates 2b only have the coating 80 in some regions, and only in a region that is closer to the transition region. The outer sides (gas sides) of the second separator plates 2b are only coated with a coating 90 on the web roofs. For example, the transition region can be arranged on the outlet side for oxygen or air and in regions close to this outlet, compared to regions further away from this outlet, such as in significantly distant regions, there can be a depletion of oxygen on the gas side carrying the oxygen. Here, the conductivity can be evened out near the outlet by means of the coating 80 on the opposite coolant side and thus a more even utilization of the MEA can be achieved.

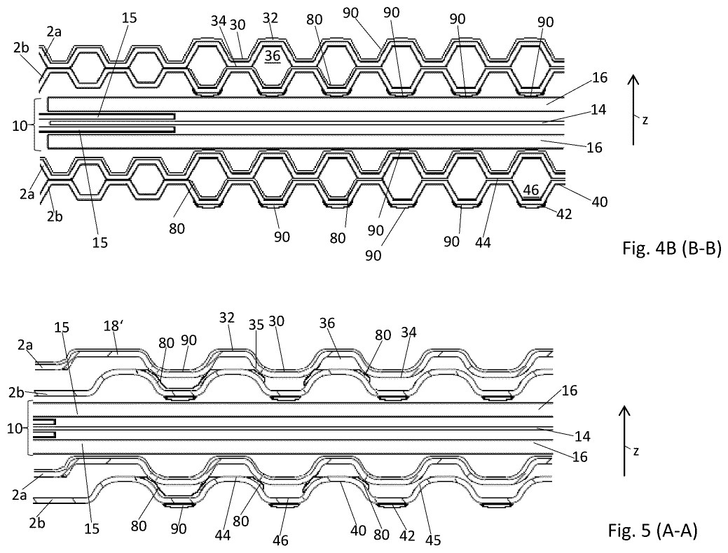

FIG. 5 schematically shows a cross-section A-A, drawn in FIG. 2, through a section of the plate stack 6 of the system 1 of FIG. 1, whereby the sectional plane is aligned in the z-direction and thus perpendicular to the plate planes of the bipolar plates 2. In the section shown, the separator plates 2a, 2b do not lie on top of each other with their web surfaces, but touch each other in the region of their flanks 35, 45. The first separator plate 2a is fully coated on the surface that faces away from the second separator plate 2b. The second separator plate 2b is coated on the surface that faces away from the first separator plate 2a in the region of its webs 42. Adjacent to the outer edge 18′ of the active region, the second separator plate 2b has a coating 80 extending over the flanks 35 and the groove 36, which on the one hand extends in the contact surfaces and on the other hand also enables the possibility of conduction through the coating 80 in the groove 36. Further towards the inside of the active region, only the flanks 35 are coated; a section without coating 80 is shown on the far right.

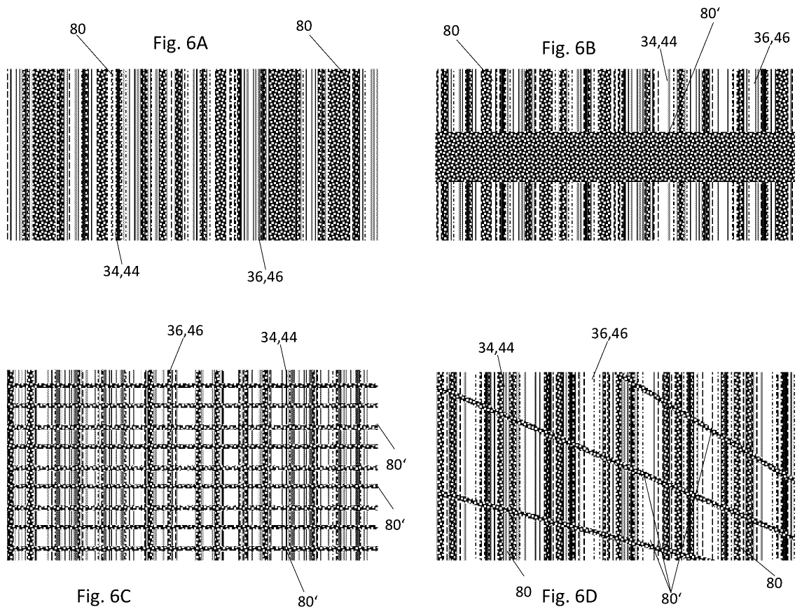

FIGS. 6A to 6D each show a top view of a coolant side of an active area of a separator plate 2a or 2b of an electrochemical system of the type of system 1 in FIG. 1. At least some of the lines separating the differently inclined or curved regions of the protrusions 34 and 44 and grooves 36 and 46 are also shown. The separator plate 2a and/or 2b has an unevenly distributed coating 80 that increases the electrical conductivity on at least one coolant side of the separator plate 2a and/or 2b. The examples in FIGS. 6A to 6D are merely exemplary patterns. Coated regions are shown hatched, uncoated regions in white.

In FIG. 6A, the coating 80 is provided on protrusions 34 or 44. However, regions with coated protrusions have different widths and sometimes extend into regions between the web crests, especially along the flanks.

In FIG. 6B, the coating 80 is provided on a part of the protrusions 34 and 44. In addition, a coating 80 forming a cross-connection 80′, resulting in an essentially orthogonal pattern of the coating, is applied.

In FIG. 6C, no coating 80 is provided along the protrusions 34 or 44. However, the coating 80 is applied substantially perpendicular to the course of the protrusions 34, 44, forming a plurality of cross-connections 80′.

In FIG. 6D, an arbitrary overlay pattern is formed by the coating 80 being partly on protrusions 34 or 44 and partly in the region in between.

FIGS. 7 to 12 each show top views of a separator plate 2a, 2b of a bipolar plate 2 of an electrochemical system. The illustration can correspond both to an illustration of a cooling side of a first separator plate 2a and a cooling side of a second separator plate 2b. It is possible that only one of the separator plates 2a, 2b has one of the configurations shown, or both have, and examples from different figures in FIGS. 7-12 can also be combined. The description refers to regions that are provided with a coating 80 that increases the electrical conductivity.

FIG. 7 shows a plan view of a separator plate 2a, 2b of an electrochemical system of the type of system 1 in FIG. 1. In the plane of the image, the first fluid flows from left to right. The active region 18 is delimited by its outer edge 18′. In the active region, there are sections 70 in which the protrusions 34 and 44 are uncoated. The sections in which the coating 80, which increases the electrical conductivity, is present are highlighted here with hatching and are distributed differently over the active region 18. In a first region I, only a short section 81 is present when viewed in the direction of flow, in which there are protrusions with the coating 80 that increases the electrical conductivity. In a centrally arranged third region III, the coating 80 is arranged evenly on the protrusions in two sections 82, 83, again shown hatched. In a second region II arranged on the right, the coating is arranged evenly on the protrusions in a region 84 shown hatched. The first region I and the third region III have the same area as the second region II. A proportion of the section 81 in the total protrusion area of the first region I is less than a proportion of the section 84 in the second region II. A proportion of the sections 82 and 83 in the total protrusion area of the third region III is less than a proportion of the section 84 in the total protrusion area of the second region II. A proportion of coated protrusion regions in the total protrusion area is distributed inhomogeneously over the entire protrusion area. The coated protrusion regions are spaced from an outer edge 18′ of the active region 18, here a circumferential section 71 is formed in which the protrusion regions are formed without the coating 80. In the present example, the raised flanks and bottoms of the grooves 36 and 46 are also configured without coating 80 in the sections shown hatched.

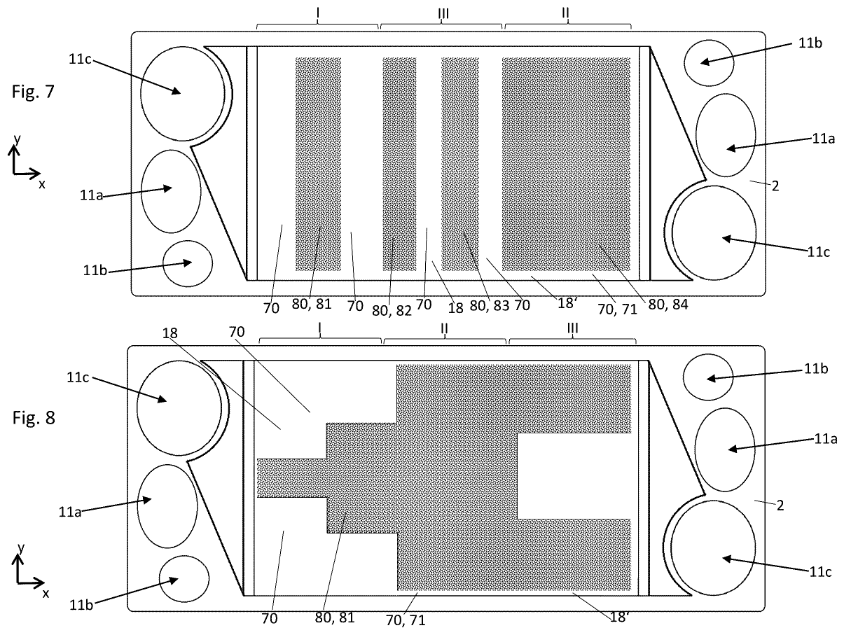

FIG. 8 shows a plan view of a bipolar plate 2 of an electrochemical system of the type of system 1 in FIG. 1 or FIG. 2. In the plane of the image, the first fluid flows from left to right. The active region 18 is delimited by its outer edge 18′, which is adjoined by a circumferential section 71 in which no coating 80 is applied. 70 indicates further sections in which no coating 80 is applied. In a section 81 shown hatched, the coating 80 of the type described above is arranged evenly on the protrusions. Section 81 extends from left to right, i.e. in the x-direction, in a <-shape. In regions where coating 80 is provided, electrical conductivity is improved. Again, three regions I, II and III are marked. The coating 80 is distributed here in such a way that a proportion of the coated protrusion regions in the first region I of the total protrusion area of the first region I is smaller than a proportion of the coated protrusion regions in the second region II of the total protrusion area of the second region II. Furthermore, a proportion of the coated protrusion regions 80 in the third region III of the total protrusion area of the third region III is, at less than 50%, significantly smaller than a proportion in the second region II and slightly smaller than a proportion in the first region I. A more homogeneous current density can be achieved by the heterogeneous distribution of the proportion of coated protrusion regions in the total protrusion area over the entire protrusion area of the active region 18. The heterogeneous distribution of coated protrusion regions in FIG. 8 may be particularly advantageous for use in bipolar plates in which the hydrogen is guided in the opposite direction to the oxygen. The largest proportion of coated protrusion regions is located in a central zone in which both a proportion of oxygen and a proportion of hydrogen have already reacted.

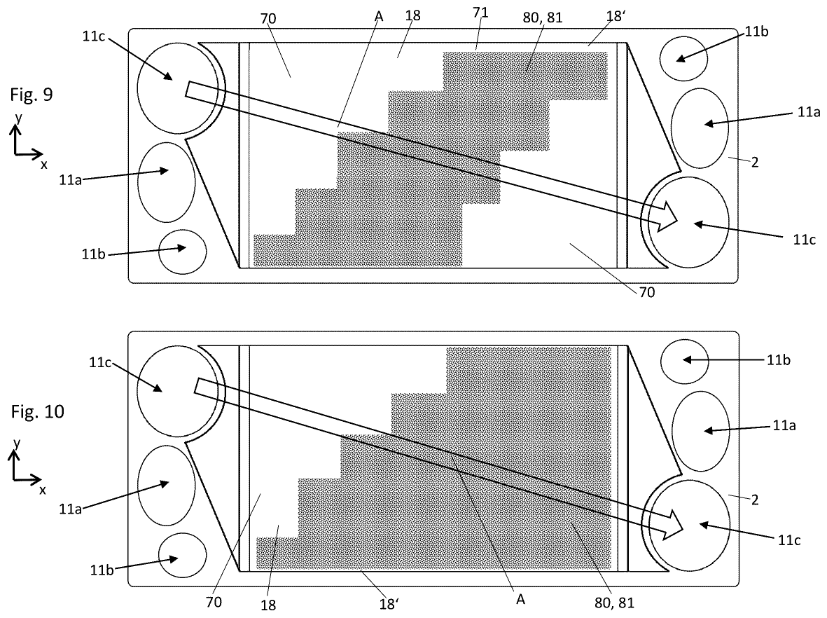

FIG. 9 shows a top view of a further example of a schematically depicted bipolar plate 2 of an electrochemical system of the type of system 1 in FIG. 1 or FIG. 2. The arrow A indicates a concentration gradient of the fluid, which is directed from the through-hole 11c (top left in FIG. 9) via the distribution region into the active region 18 and on to the through-hole 11c (bottom right in FIG. 9). The active region 18 is delimited by its outer edge 18′. In a section 81 shown hatched, the coating 80 of the type described above is evenly applied. In FIG. 9, the section 81 extends from the bottom left of the active region 18 on both sides in the form of a staircase to the top right of the active region 18. The coating 80 is spaced from the upper edge of the active region 18′; no coating 80 is provided either in the corresponding section 71 or in the sections 70. In contrast to the two preceding embodiments, not only the webs are coated here, but also the flanks of the protrusions and/or bases of the grooves 36 and 46 in the hatched section 81 are provided with the coating 80 in sections according to the pattern in FIG. 6D.

FIG. 10 shows a top view of a further example of a schematically depicted bipolar plate 2 of an electrochemical system of the type of system 1 in FIG. 1 or FIG. 2. The arrow A indicates a concentration gradient of the fluid, which is directed from the through-hole 11c (top left in FIG. 10) via the distribution region into the active region 18 and on to the through-hole 11c (bottom right in FIG. 10). The active region 18 is delimited by its outer edge 18′. In a section 81 shown hatched, a coating 80 that increases the electrical conductivity is applied evenly to the protrusions and grooves. In FIG. 10, the section 81 extends from the bottom left of the active region 18 in the form of a staircase almost to the outer right edge and to the top right corner of the active region 18. The coating 80 is only slightly spaced from the edge of the active region 18′.

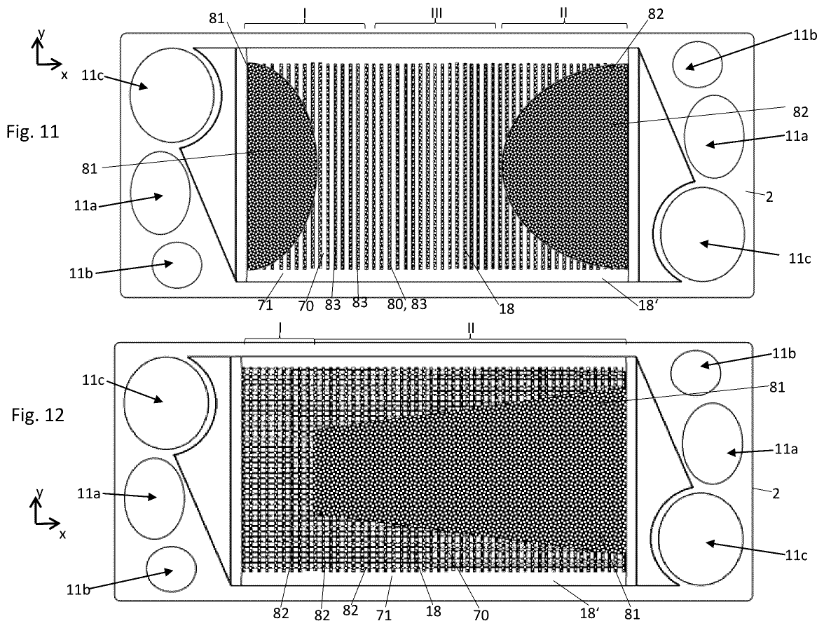

FIG. 11 shows a top view of a further example of a schematically depicted bipolar plate 2 of an electrochemical system of the type of system 1 in FIG. 1 or FIG. 2. The active region 18 is delimited by its outer edge 18′. In sections 81, 82, shown hatched, the coating 80 of the type described above is arranged evenly on the protrusions. In the sections 83 also shown hatched, on the other hand, the coating 80 extends essentially perpendicular to the course of the webs, i.e. both over protrusions, flanks and grooves, as shown in FIG. 6C. The in between sections 70 shown in white have no such coating 80. The section 81 in FIG. 11 has the shape of an elongated semicircle and is arranged on the left in the active region 18 in FIG. 11. The section 82 in FIG. 11 has the shape of a compressed semicircle and is arranged on the right in the active region 18 in FIG. 11. Strip-shaped sections 83, of which only some are marked with the reference sign 83 for the sake of clarity, extend essentially parallel to the y-axis and are arranged between the sections 81 and 82. The coating 80 is spaced from the upper and lower edges 18′ of the active region. Areas I, II and III are marked again, but the sequence from left to right is I, III and II; the third region III has the smallest proportion of raised regions with coating 80. Here, the second region II is arranged closer to the outlet opening 11 than the first region I and the third region III.

FIG. 12 shows a top view of a further example of a schematically depicted bipolar plate 2 of an electrochemical system of the type of system 1 in FIG. 1 or FIG. 2. The active region 18 is delimited by its outer edge 18′. In sections 81, 82, shown in black, the coating of the type described above is arranged evenly on the protrusions and flanks and, in section 82, also in the grooves. The protrusions of the in between sections 70 shown in white do not have such a coating 80. The section 81 in FIG. 12 has the shape of a trapezoid that extends centrally from right to left over approximately three quarters of the active region 18. Strip-shaped sections 82, of which only some are provided with the reference sign 82 for the sake of clarity, extend essentially parallel to the y-axis and are arranged essentially over the entire active region. The coating 80 is also spaced from the upper and lower edges 18′ of the active region 18. The left region, in which only the strip-shaped sections 82 are provided with the coating 80, can be considered here as first region I, the right region, in which both strip-shaped sections 82 and the trapezoidal section 81 are provided with the coating 80, can be considered here as second region II. This means that there do not always have to be three regions I, II, III, and the surface extension of these regions can also vary.

1. A bipolar plate for an electrochemical system, having a first separator plate (2a) and a second separator plate that are arranged one on top of the other, wherein
the first separator plate has, on a side that faces away from the second separator plate, embossed webs and channels for guiding a first fluid;
the second separator plate has, on a side that faces away from the first separator plate, embossed webs and channels for guiding a second fluid;
the first and second separator plates each have webs and channels on mutually facing sides for guiding a cooling medium along an inner side of the bipolar plate;
wherein at least one of the first separator plate and the second separator plate has, on the side that faces the other separator plate, coated surface regions only in sections, wherein the coated surface regions are provided with a coating that increases an electrical conductivity.

2. The bipolar plate according to claim 1, wherein a proportion of the coated surface regions on an entire surface is distributed heterogeneously over said entire surface.

3. The bipolar plate according to claim 1, wherein the proportion of the coated surface regions is formed on the side of the first separator plate that faces the second separator plate and/or wherein the proportion of the coated surface regions is formed on the side of the second separator plate that faces the first separator plate.

4. The bipolar plate according to claim 1, wherein the first separator plate has a first electrochemically active region and the second separator plate has a second electrochemically active region, wherein the first electrochemically active region and the second electrochemically active region overlap each other and form an active region of the bipolar plate in an overlapping region, wherein the coated surface regions in the active region are located on at least one side of at least one of the first separator plate and the second separator plate.

5. The bipolar plate according to claim 1, wherein the coated surface regions are formed in a region of web surfaces of one or both of the first separator plate and the second separator plate.

6. The bipolar plate according to claim 1, wherein the first separator plate and/or the second separator plate form at least one contact surface between them, wherein the coated surface regions are formed in the at least one contact surface.

7. The bipolar plate according to claim 1, wherein the coated surface regions are formed in regions between web surfaces and/or in regions between contact surfaces of the first separator plate and/or the second separator plate.

8. The bipolar plate according to claim 1, wherein the first separator plate has a first region, a second region and a third region in an electrochemically active region of at least one of its sides,
wherein the coated surface regions are distributed in such a way that a first proportion of the coated surface regions in the first region over an entire surface of the first region is smaller than a second proportion of the coated surface regions in the second region over an entire surface of the second region and/or a third proportion of the coated surface regions in the third region over an entire surface of said third region is smaller than the second proportion and/or the first proportion.

9. The bipolar plate according to claim 1, wherein the second separator plate has a first region, a second region and a third region in an electrochemically active region of at least one of its sides,
wherein the coated surface regions are distributed such that a first proportion of the coated surface regions in the first region over an entire surface of the first region is smaller than a second proportion of the coated surface regions in the second region over an entire surface of the second region and/or a third proportion of the coated surface regions in the third region over an entire surface of said third region is smaller than the second proportion and/or the first proportion.

10. The bipolar plate according to claim 8, wherein a first ratio of the first proportion and the second proportion is less than 0.9,
and/or
wherein a second ratio of the third proportion to the second proportion is less than 0.9.

11. The bipolar plate according to claim 8,
wherein at least the side of the first separator plate that faces the second separator plate is configured such that a proportion of the coated surface regions of the entire surface of the first region and/or the second region and/or the third region of the electrochemically active region differ from one another by more than 5%.

12. The bipolar plate according to claim 9,
wherein at least the side of the second separator plate that faces the first separator plate is configured such that a proportion of coated surface regions of the entire surface of the first region and/or the second region and/or the third region of the electrochemically active region differ from one another by more than 5%.

13. The bipolar plate according to claim 11, wherein only the second region has the coated surface regions.

14. The bipolar plate according to claim 1, wherein the bipolar plate is adapted to be operated at a certain operating point of an electrochemical system, wherein the certain operating point comprises a certain concentration gradient of the first fluid along a first electrochemically active region,
wherein the coating is adapted to the certain concentration gradient of the first fluid, so that a proportion of the coated surface regions in sections of the first electrochemically active region with comparatively low concentration of the first fluid is greater than a proportion of the coated surface regions in sections of the first electrochemically active region with comparatively high concentration of the first fluid.

15. The bipolar plate according to claim 4, wherein the first separator plate comprises a first inlet opening for feeding of the first fluid and a first outlet opening for discharge of the first fluid,
wherein the first inlet opening is fluidically connected to the first electrochemically active region via a first inlet region, and the first outlet opening is fluidically connected to the first electrochemically active region via a first outlet region, so that the first fluid can be conducted successively through the first inlet region, the first electrochemically active region and the first outlet region.

16. The bipolar plate according to claim 10, wherein the second region is arranged closer to an outlet opening than the first region and the third region.

17. The bipolar plate according to claim 1, configured in such a way that a flow direction of the first fluid is opposite to a flow direction of the second fluid, wherein a proportion of the coated surface regions of at least the side of the first separator plate that faces the second separator plate and/or the side of the second separator plate that faces the first separator plate increases at least in sections along the flow direction of the first fluid.

18. The bipolar plate according to claim 1, wherein at least one of the first separator plate and the second separator plate of the bipolar plate comprises a stainless steel or a titanium alloy in sections or over its entire area.

19. Bipolar plate according to claim 1, wherein the coating contains one or more of the following substances: electrically conductive materials, carbon, electrically conductive carbon layers, metal nitrides, metal oxynitrides, metal carbides, metal borides, metal silicides and/or silicon carbide, noble metals, non-noble metals, wherein the coating is single-layered or multilayered.

20. An electrochemical system comprising a plurality of bipolar plates according to claim 1.
